(19) United States
(12) Patent Application Publication
(10) Pub. No.: US 2003/0161064 A1
(43) Pub. Date: Aug. 28, 2003

(54) Hard disk unit ensuring stability of classified data

(75) Inventors: Yoshihiro Hori, Gifu-shi (JP); Toshiaki Hioki, Ogaki-shi (JP)

Correspondence Address: McDermott, Will & Emery, 600 13th Street, N.W., Washington, DC, 20005-3096, US

(73) Assignee: SANYO ELECTRIC CO., LTD.

(21) Appl. No.: 10/369,656

(22) Filed: Feb. 21, 2003

(30) Foreign Application Priority Data
Feb. 26, 2002 (JP) 2002-049763(P)

(51) Int. Cl. G11B 5/02; G11B 19/02

(52) U.S. Cl. 360/55; 360/69

(57) ABSTRACT

In a hard disk unit, encrypted content data is stored in two hard disks by a storage read processing unit. A license required to decrypt the encrypted content data is stored in a secure data storage region of a memory unit. The memory unit is formed by a semiconductor device, and can be accessed independent of the hard disk units.

### BACKGROUND OF THE INVENTION

1. Field of the Invention

The present invention relates to a hard disk unit storing a license required to decrypt and reproduce encrypted data obtained using a data distribution system that allows copyright protection on copied information, particularly to a hard disk unit that allows copyright protection on information copied in a storage apparatus capable of multi-access.

2. Description of the Background Art

By virtue of the progress in digital networks such as the Internet in these few years, each user can now easily access network information through individual-oriented terminals such a cellular phone or the like.

In such digital networks, information is transmitted as digital data. It is now possible to obtain copied music data and video data transmitted via the aforementioned digital network without degradation in the audio quality and picture quality of the copied information, even in the case where the copying operation is carried out by an individual user.

Thus, there is a possibility of the copyright of the copyright owner being significantly infringed unless some appropriate measures to protect copyrights are taken when content data subject to copyright protection such as music data and image data are to be transmitted through the digital network.

However, if copyright protection is given top priority so that distribution of content data through the disseminating digital network is suppressed, the copyright owner who can essentially collect a predetermined copyright royalty for distribution of copyrighted data will also incur some of this benefit.

Sufficient measures must be taken in distributing content data through the digital network for the purpose of copyright protection since distribution per se is an act subject to restriction based on the copyright owner's right of transmission to the public.

In view of the foregoing, content data such as music data and image data that is a copyrighted work transmitted to the public through a digital network, once received, must be prevented from being further copied without permission.

Thus, a data distribution system is proposed in which a distribution server storing encrypted content data that is an encrypted version of content data distributes the encrypted content data towards a memory card loaded to the terminal device such as a cellular phone. In this data distribution system, a public encryption key of a memory card authenticated in advance by a certificate authority and a certificate thereof are transmitted to the distribution server when distribution of encrypted content data is requested. Upon confirming reception of the authorized certificate by the distribution server, the encrypted content data as well as the license required to decrypt encrypted content data are transmitted to the memory card. The license includes a decryption key to decrypt encrypted content data (also called “content key” hereinafter), a license ID to identify the license, and control information to restrict usage of the license. When a license is to be transmitted from a distribution server to the memory card, the distribution server and the memory card respectively generate a session key to exchange the keys therebetween to establish an encryption communication path.

Eventually, the distribution server transmits the license to the memory card via the established encryption communication path. In the transmission process, the memory card stores the received encrypted content data and license in each internal memory.

When the encrypted content data stored in the memory card is to be reproduced, the memory card is first loaded to a cellular phone. This cellular phone has the normal conversation function and also a dedicated circuit to read out the encrypted content data and content key from the memory card to decrypt and reproduce encrypted content data for output. When a content key is to be read out, an encryption communication path is established between the memory card and the dedicated circuit to allow transmission from the memory card to the dedicated circuit via the encryption communication path.

The memory card is also capable of transferring or copying a license with respect to another memory card. In this case, the license is transferred from the source memory card to the destination memory card upon establishing an encryption communication path between the source memory card and the destination memory card, likewise the transmission of a license from a distribution server. Whether the license is to be transferred or copied depends upon the control information included in the license.

Thus, the user of a cellular phone can receive encrypted content data and a license from a distribution server through a cellular phone network, store the contents in a memory card, and then decrypt or transfer to another memory card the encrypted content data stored in the memory card.

Transmission of a large amount of data is now allowed by virtue of broadcast network digitalization and the wide band of the digital communication path. Reflecting the change in the data transmission environment, an infrastructure is now being developed that can distribute video data that is usually of a large amount as compared to content data of music that is generally of smaller data amount.

It cannot be said that a memory card is the optimum storage medium when video data is handled from the standpoint of performance and cost. Specifically, a memory card has a small data storage capacity, low data access speed, and high unit cost of data storage per 1 bit.

A hard disk unit is known as a storage medium that has large storage capacity, high access speed, and low unit cost of data storage per 1 bit.

However, hard disk units currently available have the disadvantage of low security as a medium to store classified data such as a license that requires secrecy.

The hard disk unit also has the disadvantage that the lifetime of the apparatus is short since mobile components such as a motor are incorporated therein. The problem of low shock resistance is also noted. Access to data stored on a hard disk unit is easily disabled by a damage to the hard disk unit which is a magnetic storage medium incorporated inside. There is the problem of low storage stability in handling classified data such as a license that is not allowed to take a backup.

### SUMMARY OF THE INVENTION

In view of the foregoing, an object of the present invention is to provide a hard disk unit that ensures access to stored classified data and achieve storage stability related to classified data even in the case where read out of stored data is disabled.

A hard disk unit of the present invention inputs and outputs classified data and non-classified data, and stores the classified data and non-classified data. The hard disk unit includes an interface receiving and transferring data with an external source, a memory unit storing classified data and protecting classified data from improper access, a disk type magnetic storage medium storing non-classified data, and a storage read processing unit storing and/or reading out non-classified data into a disk type magnetic storage medium. The memory unit includes a data storage unit storing classified data, and a data administration unit establishing an encryption path with the source from which classified data is supplied or with a destination to which classified data is to be provided, and providing control of classified data input and output.

Preferably, the memory unit includes an independent semiconductor device.

Preferably, the memory unit is detachable from the hard disk unit.

Preferably, the hard disk unit further includes a select unit intermediating between the interface and the memory unit to transfer data related to the input and output processing of classified data, and intermediating between the interface and the storage read processing unit to transfer data related to the input and output processing of non-classified data.

Preferably, the interface includes a first interface transmitting and receiving classified data with the external source, and a second interface transmitting and receiving non-classified data with the external source.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a structure of a system to store contents to a hard disk unit.

FIG. 2 is a schematic block diagram to describe a reproduction process of contents stored in a hard disk unit.

FIG. 3 is a schematic diagram to describe a shift/copy process between hard disk units of contents stored in a hard disk unit.

FIG. 4 shows the characteristics of data, information and the like handled in the system of FIG. 1.

FIG. 5 shows the characteristics of data, keys, and the like used for data protection in the system of FIG. 1.

FIG. 6 is a schematic block diagram showing a structure of a download server of FIG. 1.

FIG. 7 is a schematic block diagram showing a structure of a terminal device of FIG. 1.

FIG. 8 is a block diagram showing a structure of a hard disk unit of FIG. 1.

FIG. 9 shows a structure of a storage region in a hard disk unit.

FIGS. 10 and 11 are first and second flow charts, respectively, to describe the operation of license distribution processing in the system of FIG. 1.

FIG. 12 is a diagram to describe a content storage method in a hard disk unit.

FIGS. 13 and 14 are first and second flow charts, respectively, to describe an operation of a shift/copy process of a license according to the structure of FIG. 3.

FIG. 15 is a flow chart to describe an operation of a license usage permission process according to the structure of FIG. 2.

FIG. 16 is a block diagram showing another structure of the hard disk unit of FIG. 1.

### DESCRIPTION OF THE PREFERRED EMBODIMENTS

Embodiments of the present invention will be described with reference to the drawings. In the drawings, the same or corresponding components have the same reference characters allotted, and description thereof will not be repeated.

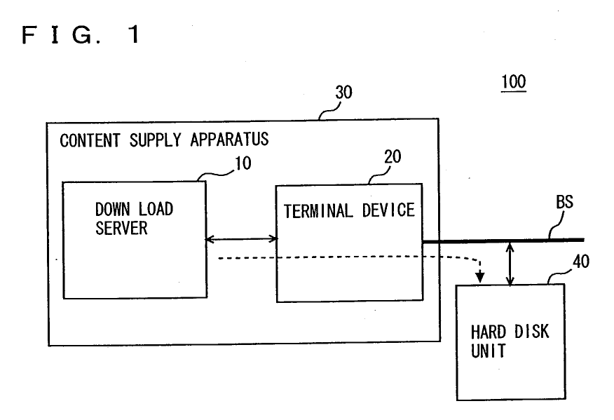

FIG. 1 schematically shows a structure to store encrypted content data and a license required to decrypt encrypted content data into a hard disk unit that has data protection capability according to the present invention.

A content supply apparatus 30 supplies encrypted content data and a license to be recorded into a hard disk unit 40. Content supply apparatus 30 is connected to hard disk unit 40 via a data bus BS to transfer data therethrough.

The following description is based on an example of a distribution system that downloads and stores into hard disk unit 40 video data via a digital network such as the Internet. However, the present invention is not limited to such an example, and is applicable to various structures such as a data recorder taking raw data to generate encrypted content data and a license, and storing the generated encrypted content data and license into hard disk unit 40, a broadcast reception system storing encrypted content data and a license received via a broadcast network into hard disk unit 40, and a composite distribution system obtaining encrypted content data via a broadcast network, and obtaining a license via a digital network. In other words, content supply apparatus 30 is an apparatus capable of transferring data with a hard disk unit 40 and transmitting the encrypted content data and the license to a hard disk unit without being restricted to the route of obtaining the encrypted content data and the license.

Also, the data handled is not limited to video data, and other content data corresponding to a copyrighted work such as music data, image data, story data, text data, computer program, game software, and the like can be handled.

In the data distribution system of FIG. 1, content supply apparatus 30 includes a download server 10 and a terminal device 20. Hard disk unit 40 is an independent unit with a detachable connector. Data bus BS allows connection through a mechanism to attach hard disk unit 40. Terminal device 20 is connected to download server 10 that distributes contents through a digital network.

Download server 10 receives from terminal device 20 a distribution request from a user of terminal device 20 to which hard disk unit 40 is attached. Download server 10 that administers video data conducts an authentication process to verify whether hard disk unit 40 attached to terminal device 20 from which a distribution request has been transmitted possesses a proper certificate, i.e. whether hard disk unit 40 is a proper storage device with protection capability. In the case where hard disk unit 40 is a proper hard disk unit, download server 10 transmits encrypted content data corresponding to video data (referred to as “content data” hereinafter) encrypted by a predetermined encryption scheme to protect the copyright and a content key required to decrypt such encrypted content data to terminal device 20 with respect to hard disk unit 40.

Terminal device 20 conducts an intermediary process between download server 10 and hard disk unit 40 to store the encrypted content data and license into hard disk unit 40.

In this intermediary process, a secure connection (encryption communication path) is formed between download server 10 and hard disk unit 40 for license distribution. Specifically, the license is encrypted in a decryptable form at hard disk unit 40 and then transmitted. This license is decrypted at hard disk unit 40 for storage. Establishing a secure connection will be described in detail afterwards. The process of storing a license into hard disk unit 40 is also termed “write” hereinafter.

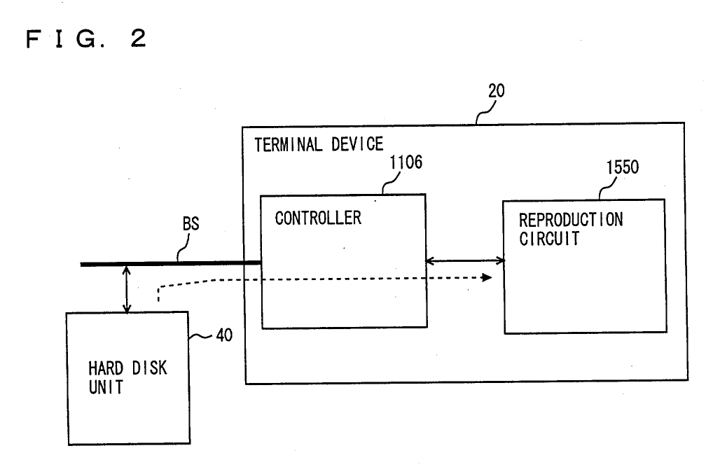

If terminal device 20 has the reproduction function, the encrypted content data and license thereof stored in hard disk unit 40 can be read out and reproduced. FIG. 2 is a schematic block diagram of a structure in which terminal device 20 capable of reproduction reads out the encrypted content data and license thereof stored in hard disk unit 40 for reproduction.

Referring to FIG. 2, terminal device 20 includes a controller 1106 providing internal control as well as control of data transmission/reception with hard disk unit 40 via data bus BS, and a reproduction circuit 1550 having a function of data protection, conducting reproduction of contents based on the encrypted content data and license. A secure connection is established between hard disk unit 40 and reproduction circuit 1550 also during content reproduction. The license used for reproduction is transmitted from hard disk unit 40 to reproduction circuit 1550 through the secure connection. In this transmission, the authenticity of reproduction circuit 1550 is verified at hard disk unit 40 according to the certification authentication process of reproduction circuit 1550. The process of transmitting a content key to reproduction circuit 1550 for reproduction of encrypted content data will be termed “usage permission”. Details thereof will be described afterwards.

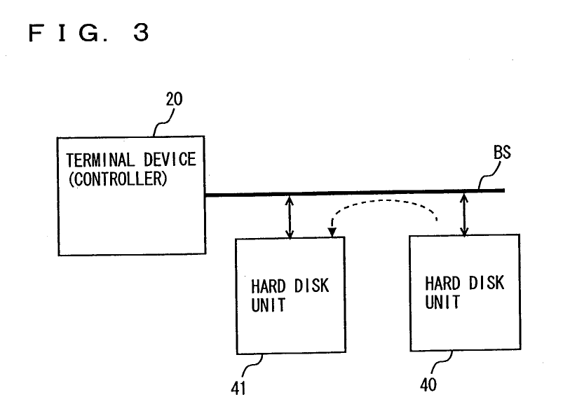

The encrypted content data and license stored in hard disk unit 40 can also be transmitted to another hard disk unit. FIG. 3 is a schematic block diagram of a structure to transmit encrypted content data and a license between two hard disk units connected to terminal device 20 via data bus BS.

A hard disk unit 41 having the same function as a hard disk unit 40 is connected to data bus BS. The controller of terminal device 20 carries out control of data transmission/reception and data intermediary between the two hard disk units 40 and 41. As to license transmission, a secure connection is established between hard disk unit 40 and hard disk unit 41 through which a license is transmitted. In this transmission, the authenticity of hard disk unit 41 is verified at hard disk unit 40 according to the certificate authentication process of hard disk unit 41. The process on the part of hard disk unit 40 that is the license transmission source is termed “transfer” when license transmission is to be conducted between two hard disk units. This “transfer” includes the cases of “copy” in which case the license remains at the transmission source and “shift” in which case the license is not left at the transmission source. Whether a license is copied or shifted depends upon the control information included in the license. At this stage, the process on part of hard disk unit 41 that is the transmission destination of license is the same “write” at the process of hard disk unit 40 of FIG. 1. Terminal device 20 and hard disk unit 40 can be viewed as content supply apparatus 30 of FIG. 1. Details will be described afterwards.

Although a structure in which two hard disk units 40 and 41 are connected to one terminal device 20 is shown in FIG. 3, a similar process can be carried out also in the case where hard disk unit 41 is attached to another terminal device that is connected to terminal device 20 through a communication table and the like, provided that data communication is allowed between the terminal devices.

In the above-described structure, the system requirements to protect the copyright of content data and to allow a user to reproduce and enjoy content data arbitrarily include: (1) a scheme per se to encrypt content data; (2) a scheme to prevent license leakage during license communication; and (3) a copyright protection function to restrict the usage method and copying of content data to prevent usage through illegal copying of the contents data.

The present embodiment will be described based on a structure that has the authentication and checking function as to the output destination of a license enhanced, preventing output of content data by preventing output of a content key to an unauthorized hard disk unit and terminal device to improve copyright protection in the processes of “write”, “transfer”, and “usage permission”.

In the following description, the process of transferring encrypted content data or a license thereof to a terminal device 20 from download server 10 is referred to as “distribution”.

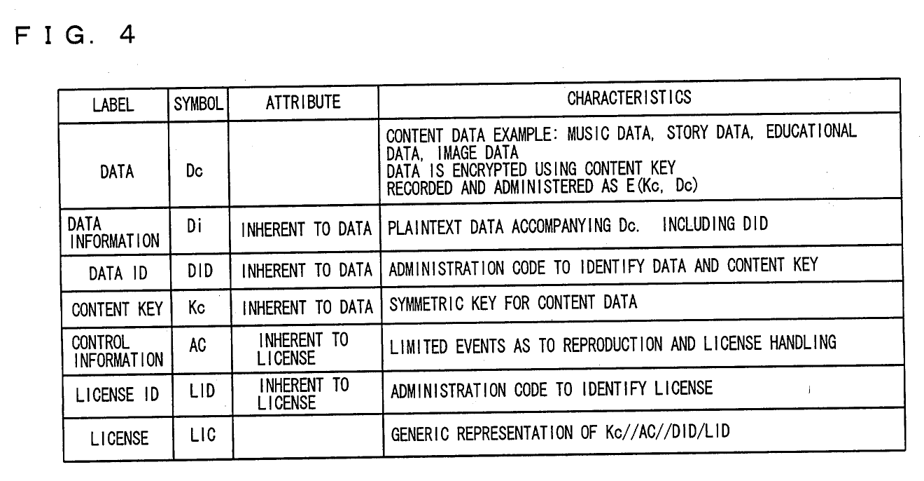

FIG. 4 is a diagram to describe the characteristics of the data and the license used in the present invention.

First, data will be described. Dc represents content data such as video data. Content data Dc is subjected to encryption that can be decrypted using a content key Kc. Encrypted content data E (Kc, Dc) subjected to encryption capable of decryption through content key Kc is transmitted from download server 10 to terminal device 20 to be recorded in a hard disk unit.

The representation of E (X, Y) implies that data Y has been encrypted using an encryption key X.

Together with the encrypted content data is distributed additional information Di as plaintext information associated with the content data from download server 10. Additional data Di includes a data ID (DID) to identify content data Dc.

A license includes a content key Kc, a license ID (LID), a data ID (DID), control information AC, and the like.

Data ID is the code to identify content data Dc and content key Kc. License ID is the code to administer distribution of a license from download server 10 to identify each license. Control information AC is required to output the license or content key from a hard disk unit to an external source, and includes the usage count (the output count of a content key by usage permission), control information associated with license shift/copy, and the like.

The license ID, data ID, content key Kc and control information AC will be generically referred together as “license LIC” hereinafter.

For the sake of simplification, it is assumed that control information AC includes the two items of a usage count which is the control information to restrict the number of times of usage (0: usage disabled; 1 to 254: usable count; 255: no limitation), and a shift/copy flag to restrict license shifting and copying (0; shift and copy inhibited; 1: only shift permitted; 2: shift and copy permitted).

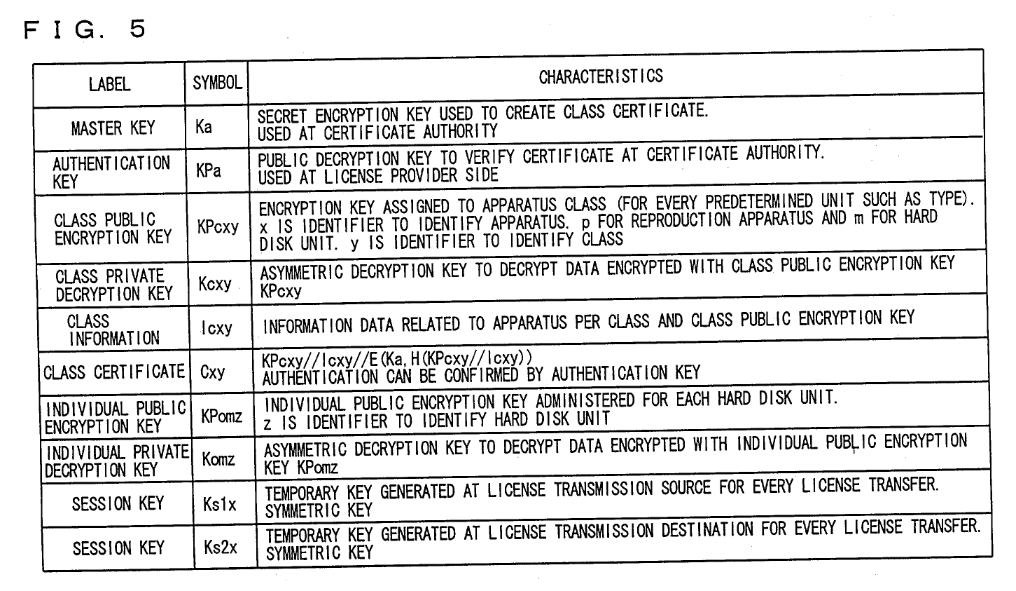

FIG. 5 is a diagram to describe the characteristics of data and keys used to establish a secure connection in the present invention.

Reproduction circuit 1550 in terminal device 20 and hard disk units 40 and 41 are provided with an inherent public encryption key KPcxy. A public encryption key KPcxy is assigned for every class of apparatus (a predetermined unit such as the type), wherein “x” is an identifier to identify a reproduction circuit and a hard disk unit. When the apparatus is a reproduction apparatus such as a reproduction circuit, x=p is set. When the apparatus is a hard disk unit, x=m is set. “y” is an identifier to identify the apparatus class. Public encryption key KPcxy is decryptable by a private decryption key Kxcy. These public encryption key KPcxy and private decryption key Kcxy have a different value for every type of a reproduction circuit and a hard disk unit. These public encryption key and private decryption key are generically referred to as “class key”. The public encryption key is called a class public encryption key, and the private decryption key is called a class private decryption key. The common unit sharing the same class key is referred to as “class”. The class differs depending upon the fabrication organization, the type of product, the fabrication lot, and the like.

A class certificate Cxy is provided for a hard disk unit and reproduction circuit. The certificate includes different information for each class of a reproduction circuit and a hard disk unit.

Certificate Cxy of a reproduction circuit and hard disk unit is recorded at the time of shipment in the reproduction circuit and hard disk unit in the form of KPcxy//lcxy//E (Ka, H (KPcxy//lcxy)). lcxy represents information data associated with each class of apparatus and class public encryption key KPcxy. H (X) implies a hash value of X which is the operation result of Hash function on data string X. X//Y implies connection between X and Y. E (Ka, H (KPcxy//lcxy)) is the signature data of KPcxy//lcxy.

KPa is a public authentication key common to the entire data distribution system, and decrypts signature data corresponding to class public encryption key KPcxy and class information lcxy encrypted using a master key Ka at the certificate authority(not shown). Master key Ka is a private encryption key used to generate signature data of a class certificate at the certificate authority.

There are a public encryption key KPomz administered for each of hard disk units 40 and 41, and a private decryption key Komz that can be used to decrypt data encrypted with public encryption key KPomz. These public encryption key and private decryption key administered for each hard disk unit are generically referred to as “individual keys”. Public encryption key KPomz is called an individual public encryption key. Private decryption key Komz is called an individual private decryption key. “z” is an identifier to identify each hard disk unit.

Symmetric keys Ks1w and Ks2w generated at download server 10, terminal device 20, and hard disk units 40 and 41 for every license distribution, transfer, and usage are employed.

These symmetric keys Ksw1 and Ks2w are unique symmetric keys generated for each “session” which is the communication unit or access unit among the download server, reproduction circuit and hard disk unit. These symmetric keys Ksw1 and Ks2w are also referred to as “session key” hereinafter. “w” is an identifier to identify each session.

Session key Ks1w is generated at the source that supplies or transmits a license. Session key Ks2w is generated at the destination to which a license is supplied or received. Specifically, a license supply apparatus such as the download server generates session key Ks1w, a reproduction circuit generates a session key Ksw2, and a hard disk unit generates session key Ks2w in a “write” operation and session key Ks1w in a “transfer” and “usage permission” operation. During respective processes, the generated session keys are exchanged. The apparatus has the function to carry out a data decryption process using a session key generated at another apparatus. By establishing a secure connection through such session keys and conducting license transmission through the secure connection, the security of processing on licenses is improved to protect the license from an attack through communication.

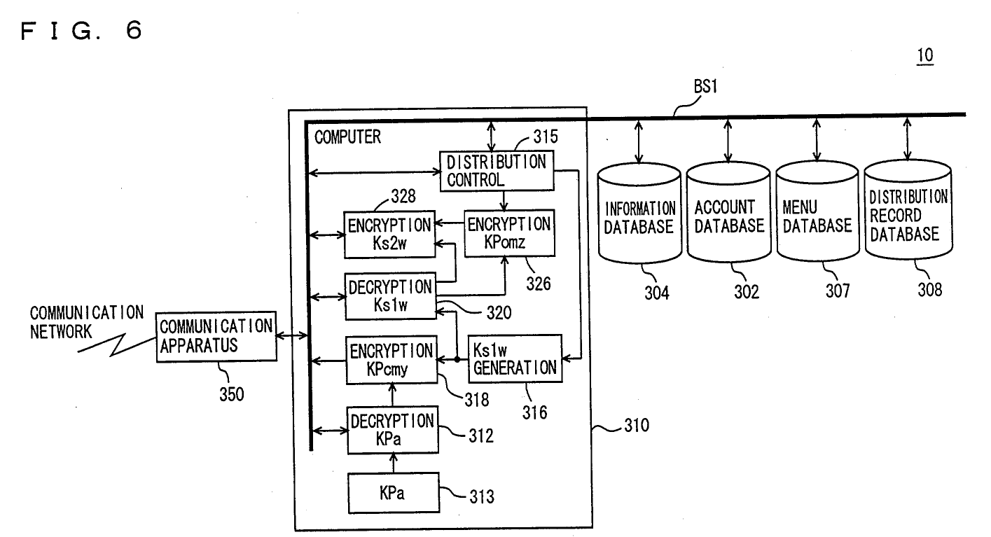

FIG. 6 is a schematic block diagram showing a structure of download server 10 of FIG. 1.

Download server 10 includes an information database 304 to store content data encrypted according to a predetermined method as well as distribution information such as a data ID, an account database 302 to store accounting information according to initiating access to content data for each terminal device user, a menu database 307 storing the menu of content data stored in information database 304, a distribution record database 308 generated for each license distribution to store a log associated with distribution such as a license ID to identify a license, a data processing unit 310 receiving via a bus BS1 data from information database 304, account database 302, menu database 307 and distribution record database 308 to carry out the predetermined process, and a communication device 350 to transfer data between a distribution carrier and data processing unit 310 via a communication network.

Data processing unit 310 includes a distribution control unit 315 to control the operation of data processing unit 310 according to data on bus BS1, a session key generation unit 316 under control of distribution control unit 315 to generate a session key Ks1w in a distribution process, an authentication key hold unit 313 storing an authentication key KPa which is a public decryption key required to decrypt a class certificate Cxy=KPcxy/lcxy//E (Ka, H (KPcxy//lcxy)) transmitted from a hard disk unit for authentication, a decryption processing unit 312 receiving class certificate Cxy from a hard disk unit via communication device 350 and bus BS1 to carry out a decryption process using authentication key KPa from authentication key hold unit 313, an encryption processing unit 318 encrypting session key Ks1w generated from session key generation unit 316 using a class public encryption key KPcxy obtained from decryption processing unit 312 to output the encrypted session key onto bus BS1, and a decryption processing unit 320 receiving from bus BS1 the transmitted data encrypted by session key Ks1w to carry out a decryption process using session key Ks1w.

Data processing unit 310 further includes an encryption processing unit 326 to encrypt content key Kc and control information AC applied from distribution control unit 315 using a individual public encryption key KPomz of a hard disk unit obtained by decryption processing unit 320, and an encryption processing unit 328 further encrypting the output of encryption processing unit 326 using a session key Ks2w applied from decryption processing unit 320 to output the further encrypted data onto bus BS1.

The operation of download server 10 in a distribution process will be described in further detail afterwards with reference to flow charts.

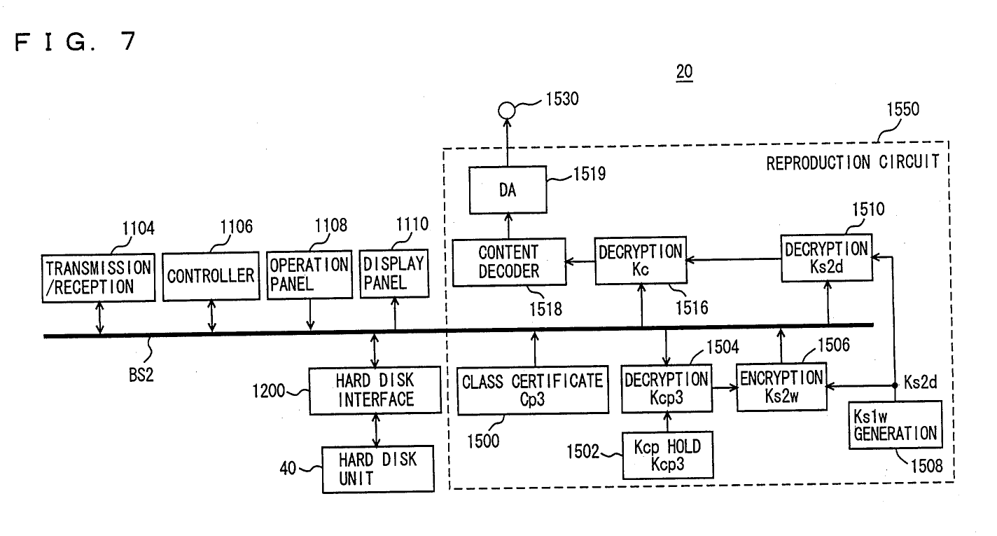

FIG. 7 is a schematic block diagram to describe a structure of terminal device 20 capable of connection with download server 10 shown in FIGS. 1 and 2 and including reproduction circuit 1550.

Terminal device 20 is connected via download server 10 and a digital network, and includes a transmitter/receiver unit 1104 for data transmission and reception, a bus BS2 to transfer data among the components in terminal device 20, a controller 1106 to control the operation of terminal device 20 via bus BS2, an operation panel 1108 to apply designation from an external source to terminal device 20, and a display panel 1110 to provide information output from controller 1106 and the like as visual information to the user.

Terminal device 20 further includes a detachable hard disk unit 40 storing content data (music data) from download server 10, and applying a decryption process, and a hard disk unit interface 1200 to control data transfer between hard disk unit 40 and bus BS2, and a reproduction circuit 1550.

Reproduction circuit 1550 includes a certificate hold unit 1500 to store certificate Cp3=KPcp3//lcp3//E (Ka, H (KPcp3//lcp3)). It is assumed that the class y of terminal device 20 is y=3 here.

Reproduction circuit 1550 further includes a Kcp hold unit 1502 storing a decryption key Kcp3 unique to each class, and a decryption processing unit 1504 decrypting the data received from bus BS2 using decryption key Kcp3 to obtain session key Ks1w generated by hard disk unit 40.

Reproduction circuit 1550 further includes a session key generation unit 1508 generating by a random number or the like a session key Ks2w, and an encryption processing unit 1506 encrypting session key Ks2w generated by session key generation unit 1508 with session key Ks1w of hard disk unit 40 obtained by decryption processing unit 1504.

Reproduction circuit 1550 further includes a decryption processing unit 1510 decrypting the data using session key Ks2w to output a content key Kc, and a decryption processing unit 1516 to decrypt encrypted content data E (Kc, Dc) using content key Kc from decryption processing unit 1510 to output content data Dc to a content decoder 1518.

Reproduction circuit 1550 further includes a content decoder 1518 receiving the output from decryption processing unit 1516 to reproduce content data Dc, a DA converter 1519 to convert the output of content decoder 1518 into an analog signal from a digital signal, and a terminal 1530 to provide the output of a reproduced video signal.

It is assumed that a hard disk interface 1200 complies with the ATA (AT Attachment) standard. Therefore, data bus BS is an ATA bus.

The operation of respective processing in each component of terminal device 20 will be described in detail with reference to flow charts afterwards.

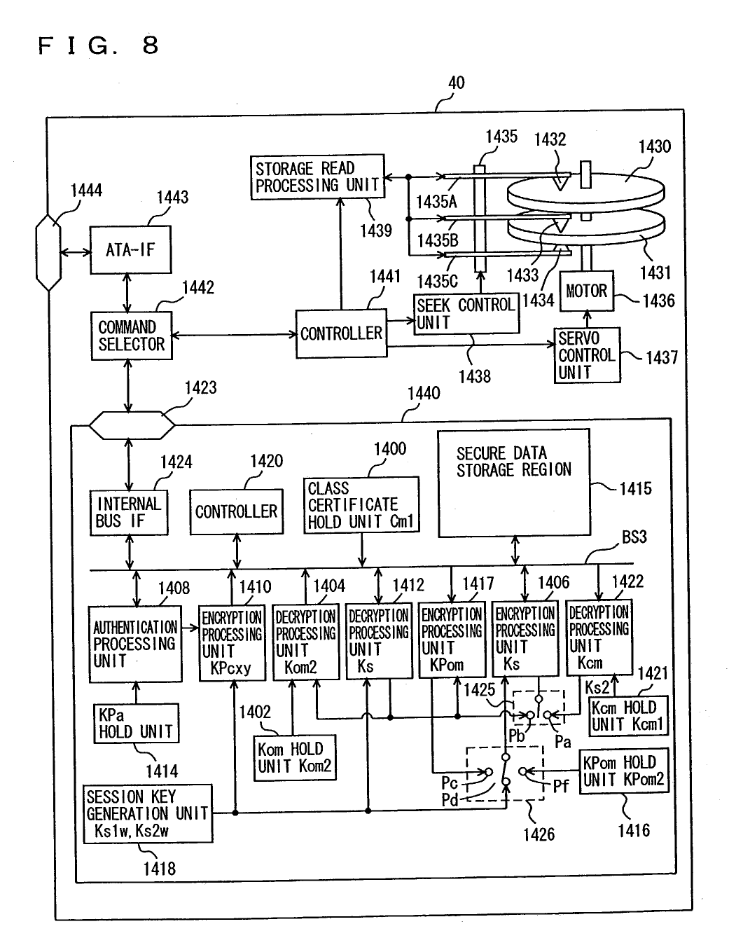

FIG. 8 is a schematic block diagram to describe a structure of hard disk unit 40 of FIG. 1. Hard disk unit 40 includes hard disks 1430 and 1431 which are disk type magnetic recording medium, heads 1432-1434, struts 1435, arms 1435A-1435C, a motor 1436, a servo control unit 1437, a seek control unit 1438, a storage read processing unit 1439, a memory unit 1440, a controller 1441, a command selector 1442, an ATA (AT Attachment) interface 1443, and a terminal 1444.

Hard disks 1430 and 1431 are media to store encrypted content data received from download server 10 or another hard disk unit. Head 1432 is fixed at the leading end of arm 1435A to store and/or read out data on one side of hard disk 1430. Head 1433 is fixed at the leading end of arm 1435B to store and/or read out the other side of hard disk 1430 and one side of hard disk 1431. Head 1434 is fixed at the leading end of arm 1435C to store and/or read out data at the other side of hard disk 1431. Arms 1435A-1435C are fixed to strut 1435.

Motor 1436 rotates hard disks 1430 and 1431 at a predetermined revolution speed. Servo control unit 1437 controls motor 1436 so as to rotate at the predetermined revolution speed under control of controller 1441. Seek control unit 1438 drives arms 1435A-1435C in the radial direction of hard disks 1430 and 1431 under control of controller 1441. Storage read processing unit 1439 stores and/or reads out under control of controller 1441 the encrypted content data with respect to hard disks 1430 and 1431 via heads 1432-1434 secured to arms 1435A-1435C.

Controller 1441 controls servo control unit 1437, seek control unit 1438 and storage read processing unit 1439 so as to receive encrypted content data from command selector 1442 and store and/or read out the received encrypted content data into a predetermined location of hard disks 1430 and 1431. Command selector 1442 receives encrypted content data and a license from ATA interface 1443 to provide the received content data to controller 1441 and the received license to memory unit 1440. ATA interface 1443 functions to transfer data between terminal 1444 and command selector 1442. Terminal 1444 is a terminal to transfer data with respect to hard disk interface 1200 of terminal device 20.

Keys KPcmy and Kcmy are provided as the class public encryption key and class private decryption key, respectively, of hard disk unit 40, and a class certificate Cmy=KPcmy//lcmy//E (Ka, H (KPcmy//lcmy)) of the hard disk unit is provided. It is assumed that hard disk unit 40 has a class identifier of y=1 assigned. Also, the private identifier z to identify a hard disk unit is established as z=2. These identifiers are administered in memory unit 1440 that handles the license.

Therefore, memory unit 1440 includes a certificate hold unit 1400 retaining certificate data Cm1=KPcmy//lcmy//E (Ka, H (KPcmy//lcmy)), a Kom hold unit 1402 retaining an individual private decryption key Kom2 that is a unique decryption key set for each hard disk unit, a Kcm hold unit 1421 retaining a class private decryption key Kcm1, and a KPom hold unit 1416 retaining a public encryption key KPom2, decryptable by individual private decryption key Kom2.

By providing encryption keys for a storage apparatus that is a hard disk unit, administration of distributed content data and encrypted content key can be executed on a hard disk unit basis, as will become apparent from the following description.

Memory unit 1440 further includes a terminal 1423 for data transfer between command selector 1442 and an internal bus interface 1424, internal bus interface 1424 transferring data with respect to terminal 1423, a bus BS3 for signal transfer with internal bus interface 1424, a decryption processing unit 1422 decrypting data applied from internal bus interface 1424 onto bus BS3 using class private decryption key Kcm1 from Kcm hold unit 1421, and providing session key Ks1w generated at an external source to hard disk unit 40 (a license transmission source) in a “write” operation to encryption processing unit 1406, an authentication processing unit 1408 receiving an authentication key KPa from KPa hold unit 1414 to conduct an authentication process of verifying the authenticity of a certificate of another apparatus (reproduction circuit or another hard disk unit) from data applied onto bus BS3 using authentication key KPa to provide the authentication result to controller 1420 and the obtained class public encryption key to encryption processing unit 1410, and an encryption processing unit 1406 encrypting data using session key Ks1w generated at download server 10 and provided from decryption processing unit 1422 or session key Ks2w generated at reproduction circuit 1550 and output from decryption processing unit 1412 for output.

Memory unit 1440 further includes a session key generation unit 1418 generating session key Ks1w in a “write” operation and session key Ks2w in the operations of “transfer” and “usage permission”, an encryption processing unit 1410 encrypting session keys Ks1w and Ks2w output from session key generation unit 1418 with class public encryption key KPcpz or KPcmz obtained by authentication processing unit 1408 to output the encrypted key to bus BS3, a decryption processing unit 1412 receiving data encrypted by session key Ks2w from bus BS3 and decrypting the received data using session key Ks2w from session key generation unit 1418, and an encryption processing unit 1417 encrypting content key Kc read out from secure data storage region 1415 in a license usage permission process with an individual public encryption key KPomz (z≠2) of another hard disk decrypted at decryption processing unit 1412 in a “transfer” operation.

Memory unit 1440 further includes a decryption processing unit 1404 to decrypt the data on bus BS3 with individual private decryption key Kom2 of hard disk unit 40 companion to individual public encryption key KPom2, a secure data storage region 1415 to store a license, and a controller 1420 transferring data with an external source via bus BS3, and receiving control information AC bus BS3 to control the operation of memory unit 1440.

For the purpose of ensuring license read out, i.e. to allow “transfer” even in the case where there is an error in hard disks 1430 and 1431 so that data cannot be read out at hard disk unit 40, secure data storage region 1415 to store a license is formed of a semiconductor memory that allows access independent of the storage/read out with respect to hard disks 1430 and 1431, and that is a storage medium more stable than hard disk units 1430 and 1431. Memory unit 1440 is formed by one semiconductor device with a tamper-resistant module from the standpoint of ensuring security.

Memory unit 1440 can be formed by a semiconductor device detachable with respect to hard disk unit 40.

Memory unit 1440 can also be formed by a plurality of semiconductor devices instead of one semiconductor device. In such a case, the wiring between the relevant semiconductor devices must be hidden to prevent license leakage through the wiring between the plurality of semiconductor devices configuring the memory unit being observed.

Thus, the provision of memory unit 1440 ensures the secrecy and stability related to a license.

Hard disk unit 40 of the present embodiment includes two hard disks 1430 and 1431. It is to be noted that data is not recorded and/or reading out to hard disks 1430 and 1431 one disk at a time. In other words, data is not recorded and/or read out onto this hard disk 1430 and then recorded and/or read out to hard disk 1431. A plurality of heads 1432-1434 move simultaneously to the same position to conduct data recording and/or read out at the same time on that site. Therefore, the entirety of two hard disks 1430 and 1431 form one data storage region.

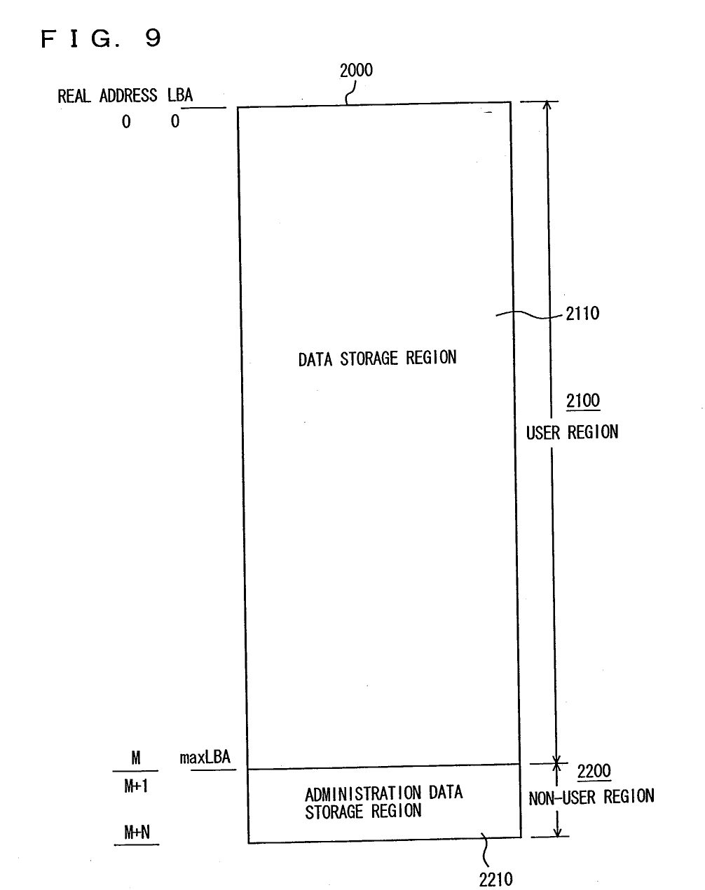

FIG. 9 shows a structure of a data storage region that is formed by the entirety of hard disks 1430 and 1431. Referring to FIG. 9, a data storage region 2000 includes a user region 2100 and a non-user region 2200. User region 2100 includes a data storage region 2110. Non-user region 2200 includes an administration data storage region 2210.

Data storage region 2000 has real addresses 0 to M+N specifying a recording location for each recording unit in the data region. User region 2100 is assigned M+1 regions specified by real addresses 0-M of the data region. Administration data storage region 2210 is assigned N regions specified by real addresses M+1 to M+N of the data regions. One data region can store 512 bytes of data.

User region 2100 is where data can be stored and/or read out directly via ATA interface 1443. The recording location is specified by a logic address called a LBA. Therefore, there are two addresses in user region 2100. Storage and/or read out is conducted by specifying a region through LBA from an external source and converted into a real address inside. This structure is advantageous in that, when the specified recording location becomes defective and usage is disabled, the LBA specifying that defective location can have the allocation of the defective recording location discarded and allocated with a substitute region prepared in advance to ensure continuity of the LBA. Data storage and/or read out into a user region via ATA interface 1443 is executed by specifying an LBA through a standard ATA command (write/read command).

It is noted that an LBA does not necessarily match the real address in FIG. 9. However, there is always one real address with respect to one LBA.

Administration data storage region 2210 is where administration data is stored. Administration data is used in hard disk unit 40 independent of the aforementioned region prepared in advance for substitution. The region where administration data is stored has administration data related to data recording stored on hard disks 1430 and 1431 (data region substitution information, error log, real address and LBA mapping table, and the like), as well as a portion of the program of controller 1441. Administration data storage region 2210 cannot have data stored and/or read out via ATA interface 1443. However, the recording location to which an LBA is assigned by a substitute process can be used as a portion of user region 2100.

In the following, it is assumed that the specification of a recording position in secure data storage region 1415 in memory-unit 1440 is effected by an entry number indicating a recording location assigned to n record regions. By specifying each assigned entry number, a license write, shift/copy and usage permission processes can be carried out. Access to memory unit 1440 is achieved by designating a plurality of extension ATA commands differing in user region 2100 in a predetermined sequence to establish a secure connection with a communication destination, and then designating an entry number to conduct storage/read out of a license. Command selector 1442 confirms the ATA command. If it is a standard ATA command, command selector 1442 provides the command to controller 1441. If the command is an extension ATA command, command selector 1442 provides the command to controller 1420 via terminal 1423 of memory unit 1440, internal bus interface 1424 and bus BS3.

The above description is provided based on a specification method of a recording position in secure data storage region 1415 by using an entry number independent of the LBA that is the logic address of user region 2100. In order to organize the storage region in hard disk unit 40 in an integrated manner, the specification method of a recording position in secure data storage region 1415 may be administrated assigning an LBA continuous to the LBA assigned to data storage region 2110. In this case, entry numbers 0-n can be assigned, for example, to maxLBA+1-maxLBA+n+1 of logic address LBA. Also, continuous LBAs can be assigned to set a user region, a secure data region, and a user region.

The structure of hard disk unit 41 is identical to that of hard disk unit 40. Therefore description thereof will not be repeated. The class identifier y of hard disk unit 41 is identical to that of hard disk unit 40, i.e., y=1, and individual identified z is set as z=4 (≠2).

Data storage region 2110 stores encrypted content data E (Kc, Dc), additional information Di, a reproduction list of encrypted content data, and a license administration file for license administration. Administration data storage region 2210 stores administration information required to store and/or read out data in data storage region 2110.

The process related to a license of FIGS. 1, 2 and 3 will be described in detail hereinafter.

[Distribution]

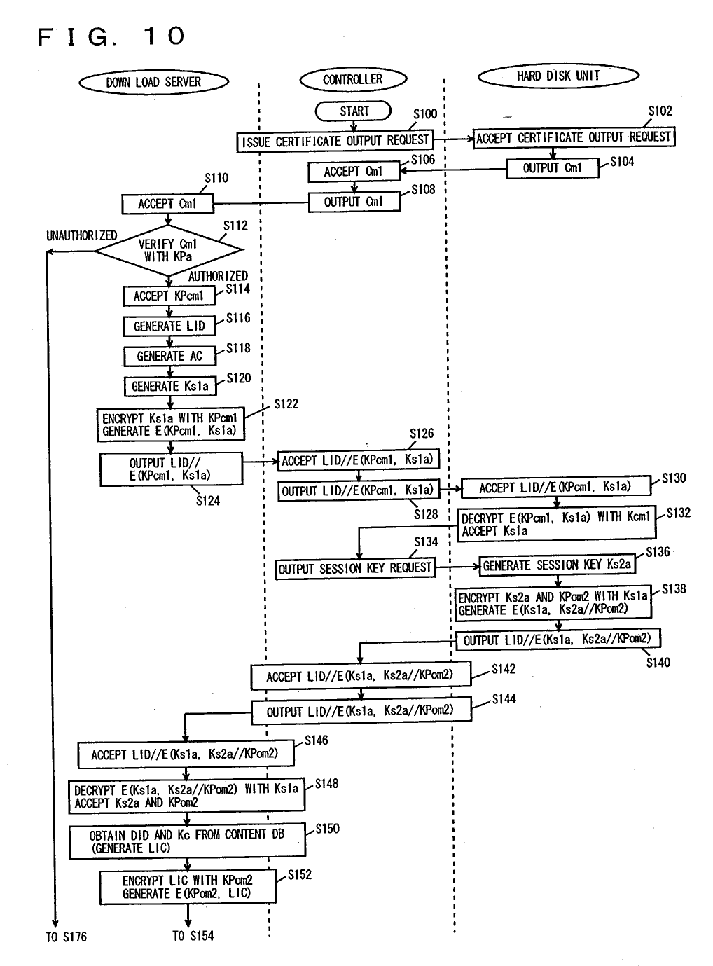

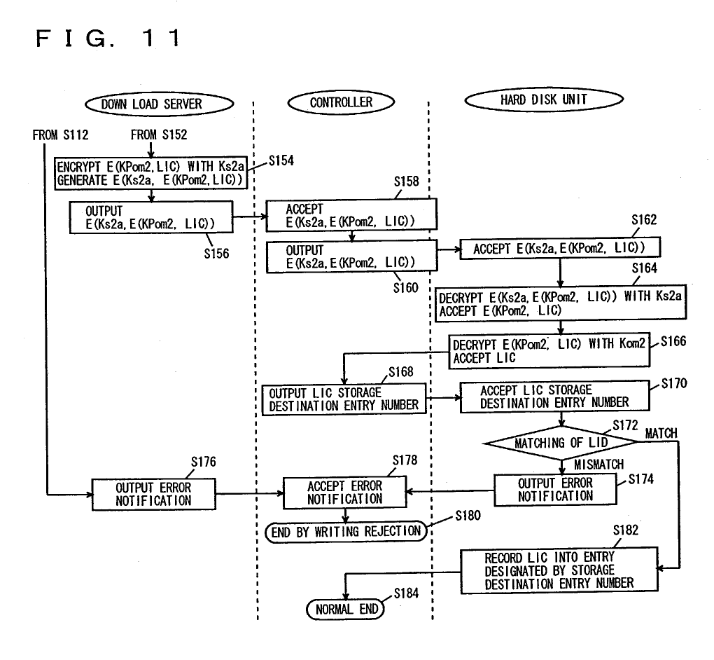

Distribution of a license required to decrypt encrypted content data from download server 10 to hard disk unit 40 of FIG. 1 will be described with reference to the first and second flow charts of FIGS. 10 and 11 corresponding to license distribution from download server 10 of FIG. 1. Hard disk unit 40 conducts “write” operation.

It is assumed that, prior to the process of FIG. 10, the user of terminal device 20 has established communication with download server 10 via a telephone network, and obtained a data ID of the content that is to be downloaded. Also, it is assumed that the storage status of secure data storage region 1415 of hard disk unit 40 issued a distribution request towards download server 10 to confirm that there is an empty entry in secure data storage region 1415, and obtain the entry number of the destination specifying a storage location on secure data storage region 1415. Furthermore, data input/output and designation to hard disk unit 40 according to the present flowchart are conducted using an extension ATA command.

Referring to FIG. 10, license distribution is designated by the user of terminal device 20 via operation panel 1108.

Upon designation of license distribution, controller 1106 issues a class certificate output request to hard disk unit 40 via bus BS2 and hard disk unit interface 1200 (step S100). Command selector 1442 of hard disk unit 40 receives the certificate output request via terminal 1444 and ATA interface 1443. The received certificate output request is provided to terminal 1423 of memory unit 1440. Controller 1420 of memory unit 1440 accepts a certificate output request via terminal 1423, internal bus interface 1424 and bus BS3 (step S102). Controller 1420 reads out certificate Cm1 from certificate hold unit 1400 via bus BS3 to output certificate Cm1 via bus BS3, internal bus interface 1424 and terminal 1423. Command selector 1442 outputs certificate Cm1 to hard disk interface 1200 via ATA interface 1443 and terminal 1444 (step S104).

Controller 1106 of terminal device 20 accepts certificate Cm1 from hard disk unit 40 via hard disk interface 1200 and bus BS2 (step S106). The received certificate Cm1 is transmitted to download server 10 (step S108). Download server 10 accepts certificate data Cm1 from terminal device 20 (step S110). Decryption processing unit 312 decrypts signature data E (Ka, H (KPcm1//lcm1) of certificate Cm1=KPcm1/lcm1//E (Ka, H (KPcm1//lcm1)) output from hard disk unit 40 with authentication key KPa from authentication key hold unit 313, and provides hash value H (KPcm1//lcm1) that is decrypted data thereof to distribution control unit 315. Distribution control unit 315 calculates a hash value of H (KPcm1//lcm1) of certificate Cm1, and confirms whether that calculated hash value matches hash value H (KPcm1//lcm1) received from decryption processing unit 312. In other word, download server 10 verifies certificate Cm1 (step S112) by confirming that decryption processing unit 312 can decrypt signature data E (Ka, H (KPcm1//lcm1) of certificate Cm1 with authentication key KPa, and that distribution control unit 315 confirms that the hash value received from hard disk unit 40 that is the transmission source matches its own calculated hash value.

Distribution control unit 315 conducts an authentication process of whether a certificate is received or not subject to encryption to verify the authenticity of a proper apparatus from the decryption processing result of decryption processing unit 312. When determination is made of a proper certificate, distribution control unit 315 proceeds to the next process (step S114). When the certificate is not a proper one, unauthorization is perceived to output an error notification to terminal device, 20 (step S176). Terminal device 20 accepts the error notification (step S178), and the distribution operation ends by write rejection (step S180).

When confirmation is made of an access from a terminal device attached with a hard disk unit that possesses a proper certificate as a result of authentication, distribution control unit 315 at download server 10 accepts class public encryption key KPcm1 from hard disk unit 40 (step S114), and generates a license ID to identify the license of which distribution is requested (step S116).

Then, distribution control unit 315 generates control information AC (step S118). Session key generation unit 316 generates session key Ks1a for distribution (step S120). Session key Ksla is encrypted by encryption processing unit 318 with a class public encryption key KPcm1 corresponding to hard disk unit 40 obtained by decryption processing unit 312 (step S122).

Distribution control unit 315 transmits the license ID and encrypted session key Ks1a as data LID//E (KPcm1, Ks1a) to terminal device 20 via bus BS1 and communication device 350 (step S124).

Upon reception of data LID//E (KPcm1, Ks1a) at terminal device 20 (step S126), controller 1106 outputs data LID//E (KPcm1, Ks1a) to hard disk unit 40 via bus BS2 and hard disk interface 1200 (step S128). Command selector 1442 of hard disk unit 40 receives data LID//E (KPcm1, Ks1a) via terminal 1444 and ATA interface 1443 to provide the received data LID//E (KPcm1, Ks1a) to terminal 1423. Then, controller 1420 of memory unit 1440 accepts data LID//E (KPcm1, Ks1a) via terminal 1423, internal bus interface 1424 and bus BS3 (step S 130). Controller 1420 provides encrypted data E (KPcm1, Ks1a) to decryption processing unit 1422 via bus BS3. Decryption processing unit 1422 applies a decryption process with class private decryption key Kcm1 unique to hard disk unit 40 stored in Kcm hold unit 1421 to decrypt session key Ks1a, and accepts session key Ks1a (step S132).

Distribution control unit 315 of download server 10 transmits a session key output request to terminal device 20 via bus BS1 and communication device 350. Controller 1106 of terminal device 20 receives and provides to hard disk unit 40 the session key output request via hard disk interface 1200 (step S134). Command selector 1442 of hard disk unit 40 receives the session key output request via terminal 1444 and ATA interface 1443 to output the received session key output request to terminal 1423 of memory unit 1440. Controller 1420 of memory unit 1440 accepts the session key output request via terminal 1423, internal bus interface 1424 and bus BS3 to control session key generation unit 1418 to generate a session key. Session key generation unit 1418 generates session key Ks2a (step S136).

Encryption processing unit 1406 uses session key Ks1a applied from decryption processing unit 1422 via a contact Pa of switch 1442 to encrypt session key Ks2a applied via a contact Pd of switch 1446 and individual public encryption key KPom2 applied via a contact Pf of switch 1426 as one data train to output encrypted data E (Ks1a, Ks2a//KPom2) onto bus BS3 (step S138). Controller 1420 outputs data LID//E (Ks1a, Ks2a//KPom2) which is encrypted data E (KS1a, Ks2a//KPom2) output on bus BS3 added with a license ID (LID) to command selector 1442 via bus BS3, internal bus interface 1424 and terminal 1423. Command selector 1442 transmits data LID//E (Ks1a, Ks2a//KPom2) to terminal device 20 via ATA interface 1443 and terminal 1444 (step S140).

Terminal device 20 receives data LID//E (Ks1a, Ks2a//KPom2) (step S142). The received data LID//E (Ks1a, Ks2a//KPom2) is transmitted to download server 10 (step S144).

Download server 10 receives data LID//E (Ks1a, Ks2a//KPom2) (step S146). Decryption processing unit 320 decrypts encrypted data LID//E (Ks1a, Ks2a//KPom2) using session key Ks1a, and accepts session key Ks2a generated at hard disk unit 40 and individual public encryption key KPom2 of hard disk unit 40 (step S148).

Distribution control unit 315 obtains a data ID (DID) and content key Kc from information database 304 to generate a license LIC (step S150). Then, distribution control unit 315 provides the generated license LIC, i.e., license IC, data ID, content key Kc and control information AC to encryption processing unit 326. Encryption processing unit 326 encrypts the license LUC by individual public encryption key KPom2 of hard disk unit 40 obtained by decryption processing unit 320 to generate encrypted data E (KPom2, LIC) (step S152).

Referring to FIG. 11, encryption processing unit 328 encrypts encrypted data E (KPom2, LIC) from encryption processing unit 326 to further encrypt the same by session key Ks2a decrypted by decryption processing unit 320 to generate encrypted data E (Ks2a, E (KPom2, LIC)) (step S154). Distribution control unit 315 provides encrypted data E (Ks2a, E (KPom2, LIC)) to terminal device 20 via bus BS1 and communication device 350 (step S156). Terminal device 20 accepts encrypted data E (Ks2a, E (KPom2, LIC)) (step S158).

Controller 1106 of terminal device 20 provides encrypted data E (Ks2a, E (KPom2, LIC)) to hard disk unit 40 via bus BS2 and hard disk interface 1200 (step S160). Command selector 1442 of hard disk unit 40 receives encrypted data E (Ks2a, E (KPom2, LIC)) via terminal 1444 and ATA interface 1443 to provide the received encrypted data E (Ks2a, E (K,Pom2, LIC)) to terminal 1423 of memory unit 1440. Controller 1420 of memory unit 1440 accepts encrypted data E (Ks2a, E (KPom2, LIC)) via internal bus interface 1424 and bus BS3 (step S162). Controller 1420 provides the accepted encrypted data E (Ks2a, E (KPom2, LIC)) to decryption processing unit 1412 via bus BS3. Decryption processing unit 1412 decrypts encrypted data E (Ks2a, E (KPom2, LIC)) with session key Ks2a from session key generation unit 1418, and accepts encrypted data E (KPom2, LIC) (step 164).

Accordingly, decryption processing unit 1404 decrypts encrypted data E (Ks2a, E (KPom2, LIC)) from decryption processing unit 1412 with individual private decryption key Kom2 from Kom hold unit 1402 to accept the license LIC (step 166). In response, controller 1106 of terminal device 20 outputs the entry number to store the license LIC to hard disk unit 40 via bus BS2 and hard disk interface 1200 (step S168). Command selector 1142 of hard disk unit 40 receives the entry number via terminal 1444 and ATA interface 1443 to output the received entry number to terminal 1423 of memory unit 1440.

Controller 1420 of memory unit 1440 accepts the entry number via terminal 1423, internal bus interface 1424 and bus BS3 (step S170). Controller 1420 determines whether the already-received license ID matches the license ID included in the received license LIC received at step S166 (step S172). When the license IDs do not match, an error notification is output to command selector 1442 via bus BS3, internal bus interface 1424 and terminal 1423. Command selector 1442 provides the error notification to hard disk interface 1200 via ATA interface 1443 and terminal 1444 (step S174). Controller 1106 of terminal device 20 accepts the error notification via hard disk interface 1200 and bus BS2 (step S178). The distribution operation ends by write rejection (step S180).

When determination is made of the matching of the two license IDs at step S172, controller 1420 records the license LIC into a region in secure data storage region 1415 specified by the entry number received at steps S170 (step S182). The series of operation ends properly (step S184).

Although not described above, following the end of the license distribution process, controller 1106 of terminal device 20 transmits an encrypted content data distribution request to download server 10. Download server 10 receives the encrypted content data distribution request. Distribution control unit 315 of download server 10 obtains encrypted content data E (Kc, Dc) and additional information Di by information database 304 to transmit the obtained data to terminal device 20 via bus BS1 and communication device 350.

Terminal device 20 receives data E (Kc, Dc)//Di, and accepts encrypted content data E (Kc, Dc) and additional data Di. Then, controller 1106 applies encrypted content data E (Kc, Dc) and additional information Di as one content file to hard disk unit 40 via bus BS2 and hard disk interface 1200. Controller 1106 generates a license administration file including the entry number of the license stored in hard disk unit 40, a plaintext license ID, a data ID, and corresponding to encrypted content data E (Kc, Dc) and additional information Di to apply the generated license administration file to hard disk unit 40 via bus BS2 and hard disk interface 1200. Command selector 1442 at hard disk unit 40 provides the received encrypted content data E (Kc, Dc), additional information Di and license administration file to controller 1441. Controller 1441 controls storage read processing unit 1439 so as to store encrypted content data E (Kc, Dc), additional information Di and license administration file in data storage region 2110 of hard disks 1430 and 1431 via heads 1432-1434. Storage read processing unit 1439 stores encrypted content data E (Kc, Dc), additional information Di and the license administration file into hard disks 1430 and 1431.

Controller 1106 of terminal device 20 adds the names of the recorded content file and license administration file as well as information related to the encrypted content data extracted from additional information Di (song name, artist name) and the like as the information on the received contents into the reproduction list recorded in data storage region 2110 of hard disk unit 40, and the entire process ends.

Thus, a license can be distributed upon confirming that hard disk unit 40 attached to terminal device 20 and into which a license is to be stored is an apparatus that possesses a proper certificate, and public encryption key KPcm1 is a valid key at the same time. Distribution of a license to an improper hard disk unit can be inhibited.

By exchanging encryption keys respectively generated at download server 10 and hard disk unit 40, and executing encryption using each received encryption key to transmit encrypted data to the other party, mutual authentication can be conducted at respective transmission and reception of encrypted data to improve the security of the data distribution system.

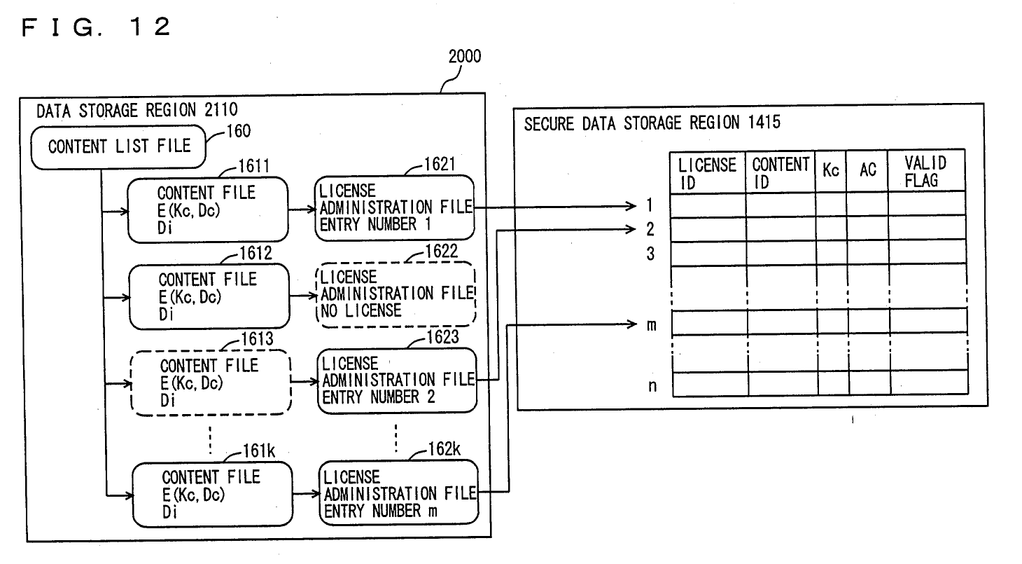

FIG. 12 shows data storage region 2110 and security data storage region 1415 of hard disk unit 40. Data storage region 2110 stores a reproduction content list file 160, content files 1611-161k, and license administration files 1621-162k. Content files 1611-161k store the received encrypted content data E (Kc, Dc) and additional information Di as one file. License administration files 1621-162k are stored corresponding to content files 1611-161k to store the entry of the license LIC stored in secure data storage region 1415.

When encrypted content data and the license are received from download server 10, or when encrypted content data is received from another hard disk unit by a copy/shift process, hard disk unit 40 stores encrypted content data in hard disks 1430 and 1431 to store a license in secure data storage region 1415.

The license of encrypted content data transmitted to hard disk unit 40 is stored in a region specified by the entry of secure data storage region 1415. By reading out the license administration file of reproduction content list file 160 stored in data storage region 2110 of hard disks 1430 and 1431, the entry number on secure data storage region 1415 where a license is stored can be obtained. A license corresponding to the obtained entry number can be read out from secure data storage region 1415.

License administration file 1622 depicted in dotted lines indicates that it is not actually recorded. Content file 1612 represents that reproduction is not possible, though present, since there is no license. This corresponds to the case where terminal device 20 has received only encrypted content data from another terminal device or when only the license is shifted to another hard disk unit.

Also, content file 1613 indicated in dotted lines corresponds to a case, where, for example, terminal device 20 has received encrypted content data and the license from download server 10, and has transmitted only the received encrypted content data to another terminal device. This means that encrypted content data is absent whereas the license is present in secure data storage region 1415.

[Shift/Copy Process Between Hard Disk Units]

As described above, data stored in data storage region 2110 of hard disk unit 40 can be stored and/or read out by a standard ATA command. Therefore, according to the structure of FIG. 3, encrypted content data stored in hard disk unit 40 can be copied arbitrarily to hard disk unit 41. However, the encrypted content data cannot be reproduced at hard disk unit 41, even if copied, unless a license required to decrypt the copied content data is obtained.

In the structure of FIG. 1, license distribution with hard disk unit 41 can be received instead of hard disk unit 40 at terminal device 20 according to the flow charts of FIGS. 10 and 11. According to the structure of FIG. 3, a license stored in hard disk unit 40 can be shifted or copied to hard disk unit 41. The process at hard disk unit 40 is called “transfer” whereas the process at hard disk unit 41 is “write”.

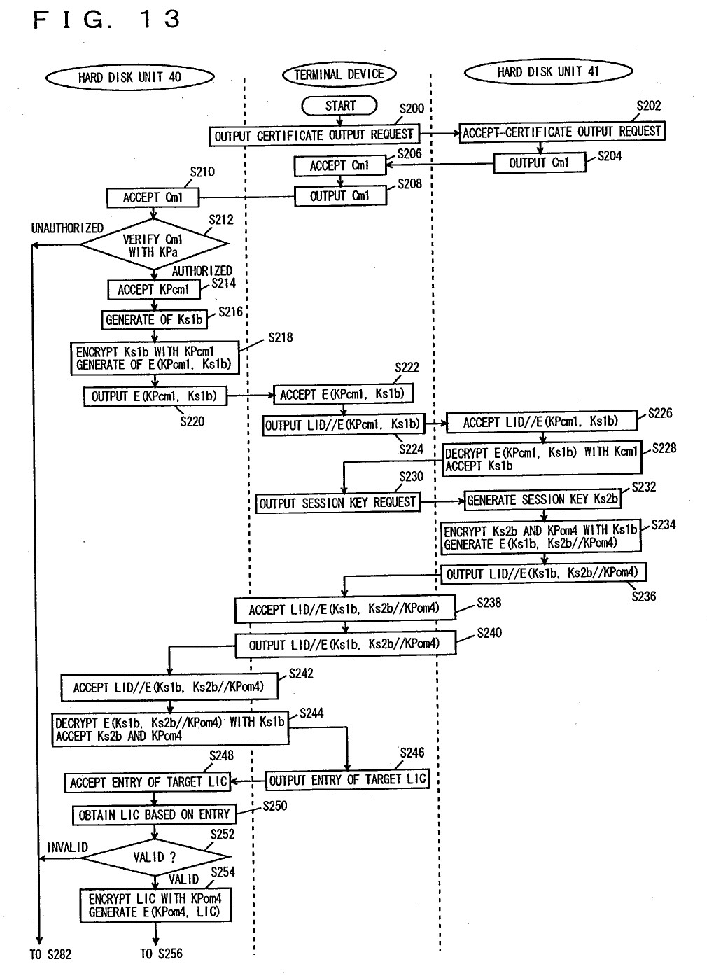

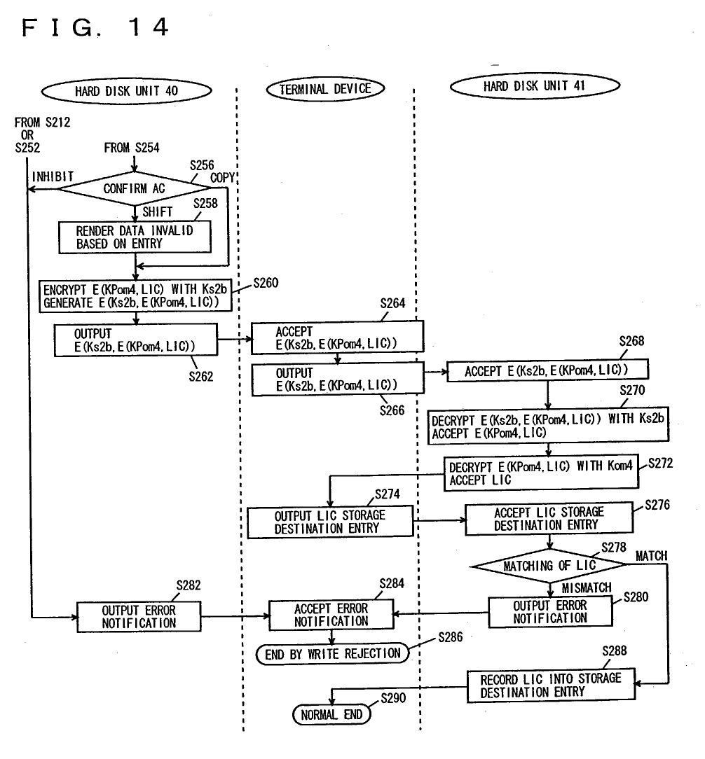

FIGS. 13 and 14 are first and second flow charts, respectively, to shift or copy a license recorded in hard disk unit 40 of FIG. 3 to hard disk unit 41. The process according to the flow charts of FIGS. 13 and 14 is called shift/copy. It is assumed that, prior to the process of FIG. 13, controller 1106 of terminal device 20 is connected to input means (not shown) to specify the contents for license transfer and issue a license shift/copy request; has identified a content administration file of a license that is to be copied or shifted from content list file 160 in hard disk unit 40 that is the transmission source to obtain an entry number where the license to be shifted or copied is stored by referring to the identified content administration file; and confirmation is made of the entry number of an empty region in secure data storage region 1415 of hard disk unit 41 that is the reception destination.

Referring to FIG. 13, controller 1106 of terminal device 20 transmits a certificate output request to hard disk unit 41 via bus BS2 when a user designates a shift/copy request (step S200). In response, control proceeds to hard disk unit 41. Command selector 1442 receives the certificate output request via terminal 1444 and ATA interface 1443 to provide the received certificate output request to terminal 1423 of memory unit 1440.

Controller 1420 of memory unit 1440 receives the certificate output request via terminal 1423, internal bus interface 1424 and bus BS3 (step S202). In response, controller 1420 reads out certificate Cm1 from certificate hold unit 1440 via bus BS3 to provide the read out certificate Cm1 to command selector 1442 via bus BS3, internal bus interface 1424 and terminal 1423. Command selector 1442 provides certificate Cm1 to controller 1106 of terminal device 20 via ATA interface 1443 and terminal 1444 (step S204). Then, control proceeds to terminal device 20. Controller 1106 accepts certificate Cm1 via bus BS.(step S206). Certificate Cm1 of hard disk unit 41 is transmitted to hard disk unit 40 via bus BS(step S208).

Then, control proceeds to hard disk unit 40. Command selector 1442 of hard disk unit 40 accepts certificate Cm1 via terminal 1444 and ATA interface 1443 (step S210). Command selector 1442 provides certificate Cm1 to terminal 1423 of memory unit 1440. Controller 1420 of memory unit 1440 receives certificate Cm1 via terminal 1423, internal bus interface 1424 and bus BS3 to provide the received certificate Cm1 to authentication processing unit 1408 via bus BS3. Authentication processing unit 1408 executes a decryption process on certificate. Cm1 using authentication key KPa from KPa hold unit 1414. The decrypted result is output to controller 1420. Controller 1420 calculates a hash value with respect to data KPcm1//lcm1 of certificate Cm1 to confirm whether that calculated hash value matches hash value H (KPcm1//lcm1) received from authentication processing unit 1408. In other words, hard disk unit 40 verifies certificate Cm1 by confirming that authentication processing unit 1408 can decrypt encrypted data E (Ka, H (KPcm1//lcm1)) of certificate Cm1 with authentication KPa, and that the hash value received from hard disk unit 41 that is the transmission source matches the hash value calculated at controller 1420 (step S212).

When determination is made of a proper certificate, controller 1420 proceeds to the next process (step S214). When the certificate is not a proper one, an authorization is set, and an error notification is output to terminal device 20 (step S282). Terminal device 20 accepts the error notification (step S284). The shift/copy process ends by write rejection (step S286).

When confirmation is made of a “transfer” to a hard disk unit that possesses a proper certificate as a result of authentication, controller 1420 receives class public encryption key KPcm1 from hard disk unit 41 (step S214), and controls session key generation unit 1418 so as to generate session key Ks1b. Session key generation unit 1418 generates session key Ks1b (step S216).

Session key Ks1b is encrypted by encryption processing unit 1410 with class public encryption key KPcm1 corresponding to hard disk unit 41 obtained by authentication processing unit 1408 (step S218).

Controller 1420 receives encrypted data E (KPcm1, Ks1b) from encryption processing unit 1410 via bus BS3 to provide the received encrypted data E (KPcm1, Ks1b) to command selector 1442 via bus BS3, internal bus interface 1424 and terminal 1423. Command selector 1442 transmits encrypted data E (KPcm1, Ks1b) to terminal device 20 via ATA interface 1443 and terminal 1444 (step S220).

Upon reception of encrypted data E (KPcm1, Ks1b) at terminal device 20 (step S222), controller 1106 provides to hard disk unit 41 via bus BSdata LID//E (KPcm1, Ks1b) that is a license ID required to identify the license that is to be shifted/copied to encrypted data E (KPcm1, Ks1b) (step S224). Then, control proceeds to hard disk unit 41. Command selector 1442 of hard disk unit 41 accepts data LID//E (YPcm1, Ks1b) via terminal 1444 and ATA interface 1443 (step S226). Command selector 1442 outputs data LID//E (KPcm1, Ks1b) to terminal 1423 of memory unit 1440. Controller 1420 of memory unit 1440 accepts data LID//E (YPcm1, Ks1b) via internal bus interface 1424 and bus BS3. Controller 1420 provides encrypted data E (KPcm1, Ks1b) to decryption processing unit 1422 via bus BS3. Decryption processing unit 1442 conducts a decryption process with class private decryption key Kcm1 unique to hard disk unit 41 stored in Kcm hold unit 1421 to decrypt session key Ks1b and accepts session key Ks1b (step S228).

Controller 1106 of terminal device 20 outputs a session key output, request to hard disk unit 41 via bus BS2 (step S230). Command selector 1442 of hard disk unit 41 receives the session key output request via terminal 1444 and ATA interface 1443. Command selector 1442 outputs the session key output request to terminal 1423 of memory unit 1440. Controller 1420 of memory unit 1440 accepts the session key output request via terminal 1423, internal bus interface 1424 and bus BS3 to control session key generation unit 1418 so as to generate a session key.

Session key generation unit 1418 generates session key Ks2b under control of controller 1420 (step S232). Encryption processing unit 1406 encrypts as one data train using session key KS1b from decryption processing unit 1422 a session key Ks2b applied via contact Pd of switch 1426 from session key generation unit 1418 and an individual public encryption key KPom4 applied via contact Pf of switch 1426 from KPom hold unit 1416 to output encrypted data E (Ks1b, Ks2b//KPom4) onto bus BS3 (step S234). Controller 1420 outputs data LID//E (Ks1b, Ks2b//KPom4) that is a license ID (LID) added to encrypted data E (Ks1b, Ks2b//KPom4) output from bus BS3 to command selector 1442 via bus BS3, internal bus interface 1424 and terminal 1423. Command selector 1442 provides data LID//E (Ks1b, Ks2b//KPom4) to terminal device 20 via ATA interface 1443 and terminal 1444 (step S236). Terminal device 20 accepts data LID//E (Ks1b, Ks2b//KPom4) via bus BS2 (step S238). The accepted data LID//E (Ks1b, Ks2b//KPom4) is output to hard disk unit 40 (step S240).

Then, control proceeds to hard disk unit 40. Command selector 1442 of hard disk unit 40 receives data LID//E (Ks1b, Ks2b//KPom4) via terminal 1444 and ATA interface 1443 (step S242). The received data LID//E (Ks1b, Ks2b//KPom4) is output to terminal 1423 of memory unit 1440. Controller 1420 of memory unit 1440 receives data LID//E (Ks1b, Ks2b//KPom4) via terminal 1423, internal bus interface 1424 and bus BS3 to provide encrypted data E (Ks1b, Ks2b//KPom4) to decryption processing unit 1412.

Decryption processing unit 1412 decrypts encrypted data E (Ks1b, Ks2b//KPom4) with session key Ks1b, and accepts session key Ks2b generated at hard disk unit 41 and individual public encryption key KPom4 of hard disk unit 41 (step S244).

Then, the entry number storing the license LIC that is the subject of shift/copy is output from controller 1106 of terminal device 20 (step S246). Command selector 1442 of hard disk unit 40 receives the entry number via terminal 1444 and ATA interface 1443. The received entry number is output to terminal 1423 of memory unit 1440. Controller 1420 of memory unit 1440 accepts the entry number storing the license LIC via internal bus interface 1424 and bus BS3 (step S248). Controller 1420 obtains the license LIC that is the subject of shift or copy from secure data storage region 1415 based on the accepted entry number (step S250). Controller 1420 determines whether the valid flag of the obtained license LIC is valid or not (step S252). When determination is made that the flag is not valid, controller 1420 outputs an error notification. The shift/copy process ends by write rejection (steps S282, S284, S286).

When determination is made that the valid flag indicates a valid state at step S252, controller 1420 provides the obtained license LIC to encryption processing unit 1417. Encryption processing unit 1417 encrypts the license LIC with individual public encryption key KPom4 from decryption processing unit 1412 to generate encrypted data E (KPom4, LIC) (step S254).

Referring to FIG. 14, controller 1420 determines whether shifting/copying of the license to hard disk unit 41 is inhibited or not based on control information AC included in the license LIC obtained at step S250 (step S256). When copy/shift is inhibited, the shift/copy process ends by write rejection via steps S282 and S284 (step S286). When license copying is permitted, control proceeds to step S260. When license shifting is permitted, controller 1420 alters the obtained valid flag to an invalid state (step S258).

When determination is made that copying is permitted at step S256, or following step S258, encryption processing unit 1406 further encrypts encrypted data E (Ks1b, Ks2b//KPom4) from encryption processing unit 1417 with session key Ks2b decrypted by decryption processing unit 1412 to generate encrypted data E (Ks2b, E (KPom4, LIC)) (step S260). Then, controller 1420 provides encrypted data E (Ks2b, E (KPom4, LIC)) to command selector 1442 via bus BS3, internal bus interface 1424 and terminal 1423. Command selector 1442 provides encrypted data E (Ks2b, E (KPom4, LIC)) to terminal device 20 via ATA interface 1443 and terminal 1444 (step S262).

Terminal device 20 accepts encrypted data E (Ks2b, E (KPom4, LIC)) (step S264). Controller 1106 of terminal device 20 outputs encrypted data E (Ks2b, E (KPom4, LIC)) to hard disk unit 41 via bus BS2 (step S266). Then, control proceeds to hard disk unit 41. Command selector 1442 of hard disk unit 41 receives encrypted data E (Ks2b, E (KPom4, LIC)) via terminal 1444 and ATA interface 1443 to provide the received encrypted data E (Ks2b, E (KPom4, LIC)) to terminal 1423 of memory unit 1440.

Controller 1420 of memory unit 1440 accepts encrypted data E (Ks2b, E (KPom4, LIC)) via terminal 1423, internal bus interface 1424 and bus BS3 (step S268). Controller 1420 provides the received encrypted data E (Ks2b, E (KPom4, LIC)) to decryption processing unit 1412 via bus BS3. Decryption processing unit 1412 decrypts encrypted data E (Ks2b, E (KPom4, LIC)) with session key Ks2b from session key generation unit 1418, and accepts encrypted data E (KPom4, LIC) (step S270).

Decryption processing unit 1410 receives encrypted data E (KPom4, LIC) from decryption processing unit 1412 to decrypt the received encrypted data E (KPom4, LIC) with individual private decryption key Kom4 from Kom hold unit 1402, and accepts a license LIC (step S272).

Controller 1106 of terminal device 20 outputs the entry number of the license LUC to hard disk unit 41 via bus BS2 (step S274). Command selector 1442 of hard disk unit 41 receives the entry number via terminal 1444 and ATA interface 1443 to provide the received entry number to terminal 1423 of memory unit 1440. Controller 1420 of memory unit 1440 accepts the entry number that is the storage destination of the license LIC via internal bus interface 1424 and bus BS3 (step S276).

Controller 1420 determines whether the license ID included in the license LIC matches the license ID already received (step S278). When the two license IDs do not match, an error notification is output to command selector 1442 via bus BS3, internal bus interface 1424 and terminal 1423. Command selector 1442 outputs the error notification to terminal device 20 via ATA interface 1443 and terminal 1444 (step S280). Controller 1106 of terminal device 20 accepts the error notification (step S284). The shift/copy process ends by write rejection (step S286).

When determination is made of matching of the two license IDs at step S278, controller 1420 records the license LIC into the region specified by the entry number received in secure data storage region 1415 (step S288). The license shift/copy operation ends properly (step S290).

The shifting or copying of encrypted content data from hard disk unit 40 to hard disk unit 41 is effected after a license shift or copy operation by reading out encrypted content data from data storage region 2110 of hard disk unit 40 and transmitting the encrypted content data to hard disk unit 41.

In the case where a license administration file with respect to the shifted or copied license is already recorded at the reception side of hard disk unit 41, the license administration file of interest is updated by writing the storage location with respect to the license administration file. In the case where the license administration file of interest is not recorded in hard disk unit 41, a license administration file is newly generated. The generated license administration file is recorded into hard disk unit 41 of the reception side.

Thus, a license can be shifted only in response to a shift request to a proper hard disk upon confirming that hard disk unit 41 attached to terminal device 20 is a proper apparatus, and that class public encryption key KPcm1 is valid. Shifting to an improper hard disk unit can be inhibited.

By exchanging encryption keys generated at respective hard disk units and executing encryption using respective received encryption keys to transmit encrypted data to the other party, mutual authentication can be conducted at respective transmission/reception of encrypted data. Therefore, the security in the license shift/copy process can be improved.

[Usage Permission Process]

As described above, hard disk unit 40 attached to terminal device 20 can directly receive encrypted content data and the license from download server 10. The process of receiving and recording directly encrypted content data from download server 10 into hard disk unit 40 has been described. Also, the process of receiving and storing through a license shift/copy process by copying encrypted content data from hard disk unit 40 to hard disk unit 41 has been described.

Here, a usage permission process of a license received at a hard disk unit by the above described various methods will be described hereinafter. It is a hard disk unit that retains a license, and a reproduction circuit 1550 of terminal device 20 that reproduces encrypted content data. When encrypted content data is to be reproduced, reproduction circuit 1550 proves authentication of a proper apparatus with respect to hard disk unit 40, and then receives a license from hard disk unit 40. Therefore, this operation corresponds to the usage of a license by reproduction circuit 1550 of terminal device 20.

It is to be noted that hard disk unit 40 conducts the usage permission process.

Referring to FIG. 2, terminal device 20 with controller 1106 and reproduction circuit 1550 transfers data with respect to hard disk unit 40 via bus BS, and reproduction circuit 1550 receives a license from hard disk unit 40. Therefore, a license usage formation process will be described based on the schematic diagram of FIG. 2.

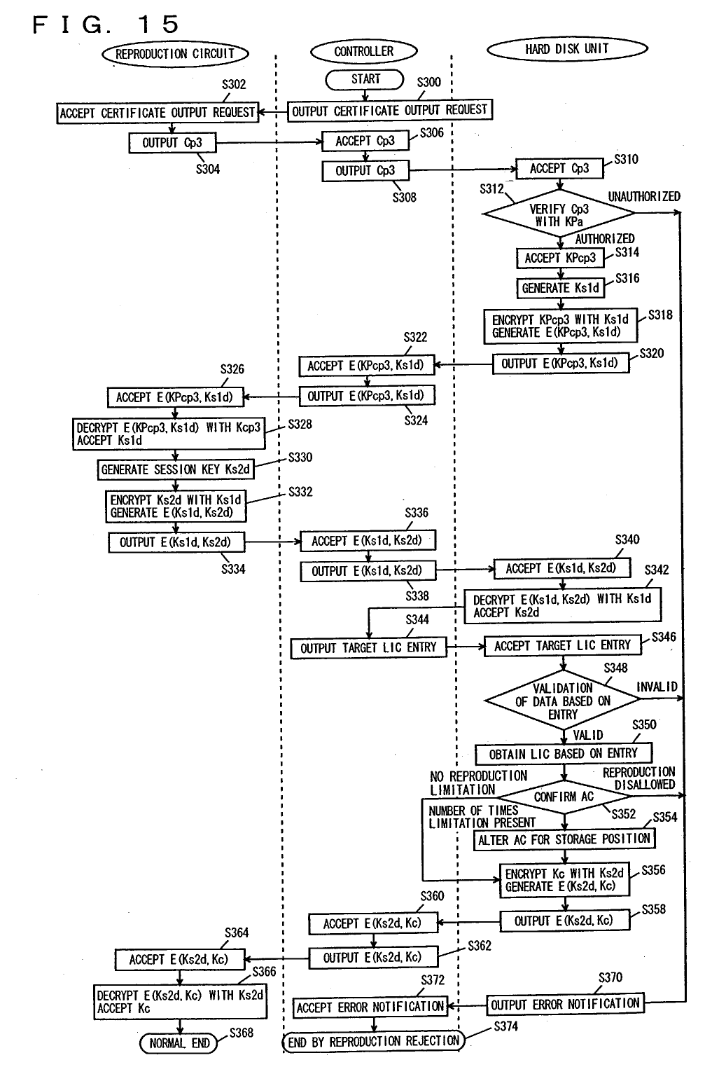

FIG. 15 is a flow chart to describe a license usage permission process to decrypt encrypted content data for reproduction circuit 1550 of terminal device 20 from hard disk unit 40. Usage of a license is allowed even in the case where hard disk unit 41 is attached to terminal device 20. In this case, a license usage permission process is carried out according to the flow chart of FIG. 15.

It is assumed that, prior to the process of FIG. 15, in accordance with the content being determined to be reproduced, the content file and the license administration file are identified and the entry number where the license is stored is obtained from the license administration file.

Referring to FIG. 15, upon initiation of a usage permission process, a reproduction request is input to terminal device 20 by a user of terminal device 20 via operation panel 1108. In response, controller 1106 provides a certificate output request via bus BS2 (step S300). Reproduction circuit 1550 accepts a certificate output request (step S302). Reproduction circuit 1550 outputs certificate Cp3 to controller 1106 (step S304). Controller 1106 accepts certificate Cp3 (step S306). Certificate Cp3 is output to hard disk unit 40 via bus BS2 (step S308).

In response, command selector 1442 of hard disk unit 40 receives certificate Cp3 via terminal 1444 and ATA interface 1443 to provide the received certificate Cp3 to terminal 1423 of memory unit 1440. Controller 1420 of memory unit 1440 accepts certificate Cp3=KPcp3//Icp3//E (Ka, H (KPcp3//lcp3)) via internal bus interface 1424 and bus B3 (step S310). Authentication processing unit 1408 decrypts signature data E (Ka, H (KPcp3//lcp3)) among the received certificate Cp3 with authentication key KPa stored in KPa hold unit 1414 to provide an encrypted hash value H (KPcp3//lcp3) thereof to controller 1420. Controller 1420 calculates a hash value with respect to data KPcp3//lcp3 of certificate Cp3 to determine whether the calculated hash value matches hash value H (KPcp3//lcp3) obtained at reproduction circuit 1550. Controller 1420 verifies certificate Cp3 received from reproduction circuit 1550 by confirming that signature data E (Ka, H (KPcp3//lcp3)) among certificate Cp3 received from reproduction circuit 1550 can be decrypted at authentication processing unit 1408, and that the two hash values match (step S312). In the case where certificate Cp3 is unauthorized, controller 1420 issues an error notification to command selector 1442 via bus BS3, internal bus interface 1424 and terminal 1423. Command selector 1442 outputs the error notification to controller 1106 of terminal device 20 via ATA interface 1443 and terminal 1444 (step S370). Controller 1106 accepts the error notification (step S372). The series of operations ends by reproduction rejection (step S374).

In the case where the certificate is authorized, controller 1420 accepts class public encryption key KPcp3 from reproduction circuit 1550 (step S314) to control session key generation unit 1418 so as to generate session key Ks1d. Session key generation unit 1418 generates session key Ks1d (step S316).

Then, session key Ks1d is encrypted by encryption processing unit 1410 with class public encryption key KPcp3 corresponding to reproduction circuit 1550 obtained by authentication processing unit 1408 (step S318).

Controller 1420 receives encrypted data E (KPcp3, Ks1d) from encryption processing unit 1410 via bus BS3 to provide the received encrypted data E (KPcp3, Ks1d) to command selector 1442 via bus BS3, internal bus interface 1424 and terminal 1423. Command selector 1442 transmits encrypted data E (KPcp3, Ks1d) to terminal device 20 via ATA interface 1443 and terminal 1444 (step S320).

In response to receiving of encrypted data E (KPcp3, Ks1d) in terminal 20 (step S322), controller 1106 outputs encrypted data E (KPcp3, Ks1d) to reproduction circuit 1550 via bus BS2 (step S324). Reproduction circuit 1550 accepts encrypted data E (KPcp3, Ks1d) via bus BS2 (step S326). Then encrypted data E (KPcp3, Ks1d) is applied to decryption processing unit 1504. Decryption processing unit 1504 decrypts encrypted data E (KPcp3, Ks1d) with class private decryption key Kcp3 from Kcp hold unit 1502, and accepts session key Ks1d generated at hard disk unit 40 (step S328).

Session key generation unit 1508 generates session key Ks2d for usage permission (step S330), and provides the generated session key Ks2d to encryption processing unit 1506. Encryption processing unit 1506 encrypts session key Ks2d from session key generation unit 1508 with session key Ks1d from decryption processing unit 1504 to generate encrypted data E (Ks1d, Ks2d) (step S332). Encrypted data E (Ks1d, Ks2d) is output to controller 1106 (step S334). Controller 1106 accepts encrypted data E (Ks1d, Ks2d) via bus BS2 (step S336), and provides encrypted data E (Ks1d, Ks2d) to hard disk unit 40 via bus BS3 (step S338).

Command selector 1442 of hard disk unit 40 receives encrypted data E (Ks1d, Ks2d) via terminal 1444 and ATA interface 1443 to output the received encrypted data E (Ks1d, Ks2d) to terminal 1423 of memory unit 1440. Decryption processing unit 1412 of memory unit 1440 receives encrypted data E (Ks1d, Ks2d) via terminal 1423, internal bus interface 1424 and bus BS3 (step S340). Decryption processing unit 1412 decrypts encrypted data E (Ks1d, Ks2d) with session key Ks1d generated at session key generation unit 1418, and accepts session key Ks2d generated at reproduction circuit 1550 (step S342).

Controller 1106 of terminal device 20 outputs the entry number obtained in advance to hard disk unit 40 via bus BS2 (step S344). Command selector 1442 of hard disk unit 40 receives the entry number via terminal 1444 and ATA interface 1443 to output the received entry number to terminal 1423 of memory unit 1440. Controller 1420 of memory unit 1440 accepts the entry number via terminal 1423, internal bus interface 1424 and bus BS3 (step S346). The validation of the license is determined based on the valid flag stored in the region specified by the received entry number in secure data storage region 1415 (step S348). When the license is invalid, the series of operations ends by reproduction rejection (steps S370-S374).

When determination is made that the license is valid at step S348, controller 1420 obtains the license LIC from the region specified by the entry number (step S350). Based on the usable count in control information AC included in the obtained license LIC, determination is made whether usage of the license is permitted or not (step S352). When the license cannot be used, the usage permission operation ends by reproduction rejection via steps S370 and S372 (step S374). In the case where usage of the license is permitted without limitation, control proceeds to step S356. When the usable count of the license is limited, controller 1420 alters the usable count in control information AC (step S354). Then, control proceeds to step S356.

Encryption processing unit 1406 encrypts content key Kc with session key Ks2d decrypted by decryption processing unit 1412 to generate encrypted data E (Ks2d, Kc) (step S356). Controller 1420 outputs encrypted data E (Ks2d, Kc) from encryption processing unit 1406 to command selector 1442 via bus BS3, internal bus interface 1424 and terminal 1423. Command selector 1442 outputs encrypted data E (Ks2d, Kc) to controller 1106 of terminal device 20 via ATA interface 1443 and terminal 1444 (step S358). Controller 1106 accepts encrypted data E (Ks2d, Kc) (step S360). Controller 1106 outputs encrypted data E (Ks2d, Kc) to decryption processing unit 1510 via bus BS2 (step S362). Decryption processing unit 1510 accepts encrypted data E (Ks2d, Kc) (step S364).

Decryption processing unit 1510 decrypts encrypted data E (Ks2d, Kc) with session key Ks2d from session key generation unit 1508, and accepts content key Kc (step S366). The usage permission process ends properly (step S368).

Following the end of the usage permission process of a license LIC to reproduction circuit 1550, controller 1106 sends a request of encrypted content data E (Kc, Dc) with respect to hard disk unit 40. Controller 1441 of hard disk unit 40 obtains encrypted content data E (Kc, Dc) from data storage region 2110 to provide the obtained encrypted content data E (Kc, Dc) to command selector 1442. Command selector 1442 provides encrypted content data E (Kc, Dc) to terminal device 20 via ATA interface 1443 and terminal 1444.

Controller 1106 of terminal device 20 obtains encrypted content data E (Kc, Dc) and provides the encrypted content data E (Kc, Dc) to reproduction circuit 1550 via bus BS2.

Decryption processing unit 1516 of reproduction circuit 1550 decrypts encrypted content data E (Kc, Dc) with content key Kc output from decryption processing unit 1510 to obtain content data Dc.

Decrypted-content data Dc is output to content decoder 1518. Content decoder 1518 reproduces the content data. DA converter 1519 converts digital signal into analog signal for output to terminal 1530. Music data is provided from terminal 1530 to an external output apparatus (for example, a television monitor). The user can enjoy the reproduced contents via the output apparatus.

The above description is based on example of a license required to decrypt encrypted content data. In the present invention, the subject is not limited to a license required to decrypt encrypted content data. Private information and credit card information of which secrecy such that a duplicate should not be present at the same time can be employed as the subject of the above-described processes.

In this case, the operation can be readily realized by replacing the data required of secrecy with content key Kc in the license.

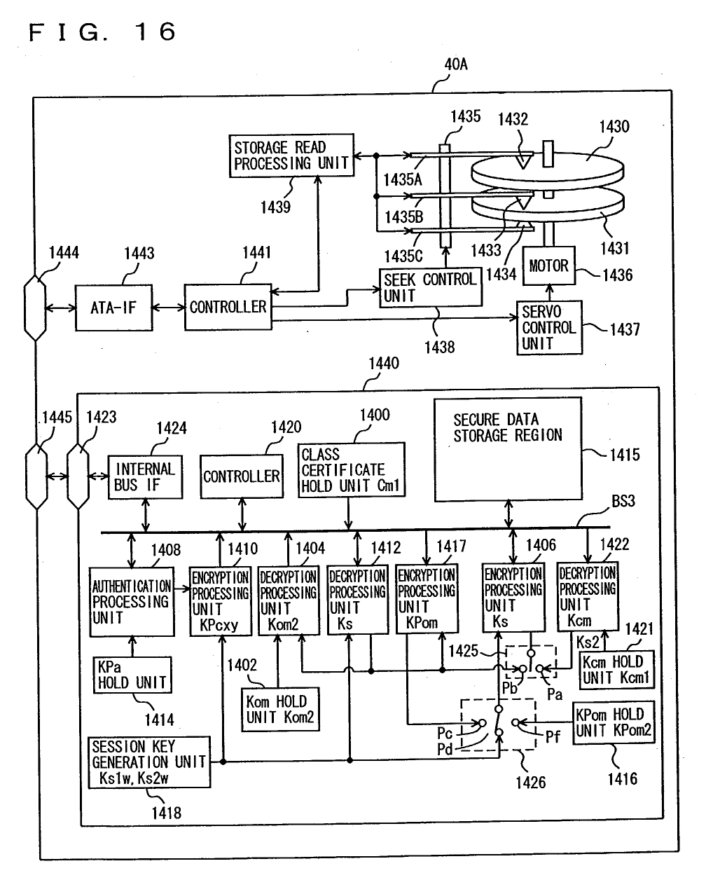

The hard disk unit of the present invention may be a hard disk unit 40A shown in FIG. 16. Referring to FIG. 16, hard disk unit 40A is similar to hard disk unit 40 provided that command selector 1442 of hard disk unit 40 is removed, and a terminal 1445 is additionally provided. Memory unit 1440 can be configured as a semiconductor device detachable with respect to hard disk unit 40A.

In hard disk unit 40A, ATA interface 1443 transfers data between terminal 1444 and controller 1441. Terminal 1445 transfers data between memory unit 1440 and terminal 1423.

Terminal 1444 inputs/outputs non-classified data such as encrypted content data to/from hard disk unit 40A. Terminal 1445 inputs/outputs classified data such as a license required to decrypt encrypted content data to/from hard disk unit 40A. Therefore, controller 1106 of terminal device 20 inputs/outputs encrypted content data to/from terminal 1444 of hard disk unit 40A via hard disk interface 1200, and inputs/outputs a license to/from terminal 1445 of hard disk unit 40A via hard disk interface 1200. At hard disk unit 40A, encrypted content data from terminal 1444 is applied to controller 1441 via ATA interface 1443. Controller 1441 controls servo control unit 1437, seek control unit 1438 and storage read processing unit 1439 so that encrypted content data is stored at a predetermined location in data storage region 2110 of hard disks 1430 and 1431. Controller 1441 controls servo control unit 1437, seek control unit 1438 and storage read processing unit 1439 so as to read out encrypted content data from a predetermined location in data storage region 2110 of hard disks 1430 and 1431, and receives the encrypted content data read out from storage read processing unit 1439. Controller 1441 provides encrypted content data received from storage read processing unit 1439 to terminal device 20 via ATA interface 1443 and terminal 1444.

Controller 1420 of memory unit 1440 applies various processing related to license reception via terminals 1445 and 1423, internal bus interface 1424, and bus BS3, and eventually stores the received license in secure data storage region 1415. In a license usage permission process, controller 1420 communicates with terminal device 20 via bus BS3, internal bus interface 1424, and terminal 1423 and 1445 to read out a license stored in secure data storage region 1415 and provides the license read out to terminal device 20 via bus BS3, internal bus interface 1424 and terminals 1423 and 1445.

Hard disk unit 40A corresponds to “write”, “shift/copy” and “usage permission”. The usage of hard disk unit 40A allows the above-described license and encrypted content data distribution process, license and encrypted content data shift/copy process, and the license and encrypted content data usage permission process to be carried out with the process related to license and the process related to encrypted content data carried out in parallel. Each process is conducted according to the flow charts of FIGS. 10, 11, 12, 13, 14 and 15.

In hard disk unit 40A, the input/output of non-classified data such as encrypted content data to/from hard disks 1430 and 1431 is carried out independent of the input/output of classified data such as a license to/from secure data storage region 1415. Therefore, the operation speed can be improved.

According to the hard disk unit of the present invention, non-classified data such as encrypted content data is stored in a hard disk whereas classified data such as a license required to decrypt encrypted content data is stored in a memory unit that has security ensured. Even in the case where a hard disk is damaged by a crash or the like, a license required to decrypt encrypted content data can be output from a hard disk unit.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A hard disk unit inputting/outputting classified data and non-classified data, and store said classified data and said non-classified data, comprising:
an interface receiving and transmitting data with respect to an external source,
a memory unit storing said classified data, and protecting said classified data from improper access,
a disk type magnetic storage medium storing said non-classified data, and
a storage read processing unit storing and/or reading said non-classified data into said disk type magnetic storage medium,
wherein said memory unit comprises
a data storage unit storing said classified data, and
a data administration unit establishing an encryption path with a source of supplying said classified data or a supply destination of said classified data, and providing control related to input and output of classified data in the case where said classified data is to be input and output.

2. The hard disk unit according to claim 1, wherein said memory unit includes an independent semiconductor device.

3. The hard disk unit according to claim 1, wherein said memory unit is detachable with respect to said hard disk unit.

4. The hard disk unit according to claim 1, further comprising a select unit intermediating between said interface and said memory unit for data transmission and reception related to an input and output process of said classified data, and intermediating between said interface and said storage read processing unit for data transmission and reception related to an input and output process of said non-classified data.

5. The hard disk unit according to claim 1, wherein said interface comprises
a first interface transmitting and receiving said classified data with said external source, and
a second interface transmitting and receiving said non-classified data with said external source.
